(19) United States
(12) Patent Application Publication
(10) Pub. No.: US 2026/0075110 A1
(43) Pub. Date: Mar. 12, 2026

(54) APPARATUS AND METHOD FOR DIAGNOSTIC COMMUNICATION IN A VEHICLE, A VEHICLE INCLUDING THE SAME, AND A VEHICLE DIAGNOSTICS APPARATUS

(71) Applicants: HYUNDAI MOTOR COMPANY, Seoul (KR); KIA CORPORATION, Seoul (KR)

(72) Inventor: Jae Hun Lee, Hwaseong-si (KR)

(73) Assignees: HYUNDAI MOTOR COMPANY, Seoul (KR); KIA CORPORATION, Seoul (KR)

(21) Appl. No.: 19/035,466

(22) Filed: Jan. 23, 2025

(30) Foreign Application Priority Data
Sep. 12, 2024 (KR) 10-2024-0124558

(51) Int. Cl. H04L 67/12; G07C 5/00; H04L 12/66

(52) U.S. Cl. CPC H04L 67/12; G07C 5/008; H04L 12/66

(57) ABSTRACT

A method for diagnostic communication in a vehicle may include receiving, by an edge communication node, a message from outside of a vehicle. The method may further include protocol converting or routing, by the edge communication node, the message. The method may further include transmitting, by the edge communication node, a diagnostic message to a control communication node in the vehicle. The method may further include receiving, by the edge communication node, a message including a diagnostic result according to the diagnostic message. The method may further include, in a transmitting operation, optionally transmitting, by the edge communication node, a message including the diagnostic result to the outside of the vehicle based on the diagnostic result.

### CROSS-REFERENCE TO RELATED APPLICATION

This application claims benefit of and priority to Korean Patent Application No. 10-2024-0124558 filed on Sep. 12, 2024, in the Korean Intellectual Property Office, the entire disclosure of which is incorporated herein by reference.

### TECHNICAL FIELD

The present disclosure relates to a method and an apparatus for diagnostic communication in a vehicle, a vehicle including the same, and a vehicle diagnostic apparatus.

### BACKGROUND

As vehicle technology advances, vehicles may be provided with various electronic control modules, and such electronic control modules may control various devices or systems mounted in the vehicle. Examples of electronic control modules may include an Electric Control Unit (ECU), a Transmission Control Unit (TCU), an Airbag Control Unit (ACU), an Antilock Braking System (ABS), a measuring instrument and driver information module, or the like.

Electronic control modules may be connected via a vehicle network and may monitor various control inputs and operating parameters transmitted via the vehicle network and control devices or systems accordingly. For example, an engine control module (ECM) may receive accelerator pedal deflation as an input to control the engine's ignition and a fuel system. In addition, the engine control module (ECM) may monitor engine speed, torque, and other operating parameters to optimize engine performance. Some controls or operating parameters monitored by one module may also be requested by one or more other modules. For example, the engine speed monitored by the engine control module may be requested by a transmission control module, a brake release module, and an instrument and driver information module. In addition, wheel speed monitored by an anti-lock brake system module may be used by the engine control module and the transmission control module for the purpose of traction control.

Because the electronic control module may be disposed within a vehicle, a vehicle diagnostic apparatus (e.g., an On Board Diagnostics device) may diagnose an electronic control module by communicating with the electronic control module according to a diagnostic communication protocol (e.g., a Diagnostics over Internet Protocol (DoIP)) via a vehicle network (e.g., Ethernet). The subject matter described in this background section is intended to promote an understanding of the background of the disclosure and thus may include subject matter that is not already known to those of ordinary skill in the art.

### SUMMARY

A method and an apparatus for diagnostic communication in a vehicle, a vehicle including the same, and a vehicle diagnostic apparatus according to an embodiment of the present disclosure may efficiently use vehicle network resources and reduce the possibility of communication failure/delay in a vehicle network.

According to an embodiment of the present disclosure, a method for diagnostic communication in a vehicle may include receiving, by an edge communication node, a message from outside of a vehicle. The method may further include protocol converting or routing, by the edge communication node, the message. The method may further include transmitting, by the edge communication node, a diagnostic message to a control communication node in the vehicle. The method may further include receiving, by the edge communication node, a message including a diagnostic result according to the diagnostic message. The method may further include, in a transmitting operation, optionally transmitting, by the edge communication node, a message including the diagnostic result to the outside of the vehicle based on the diagnostic result.

According to an embodiment of the present disclosure, an apparatus for diagnostic communication in a vehicle may include an edge communication node configured to receive a message from outside of a vehicle and protocol convert or route the message. The apparatus may further include a control communication node configured to receive the message protocol converted or routed by the edge communication node. The edge communication node may transmit a diagnostic message to the control communication node. The control communication node may transmit a message including a diagnostic result according to the diagnostic message to the edge communication node. The edge communication node may optionally transmit a message including the diagnostic result to the outside of the vehicle based on the diagnostic result.

According to an embodiment of the present disclosure, a vehicle may include a computing device having a processor and a storage medium on which one or more programs configured to be executed by the processor is recorded. The one or more programs may include commands for executing the method for diagnostic communication in the vehicle.

According to an embodiment of the present disclosure, a vehicle diagnostic apparatus may be configured to transmit a diagnostic message according to diagnostics over internet protocol (DoIP) to an edge communication node included in each of a plurality of vehicles. The vehicle diagnostic apparatus may be further configured to receive a message including a diagnostic result from at least a portion of edge communication nodes among the plurality of vehicles. The vehicle diagnostic apparatus may be further configured to determine diagnostic result information for the plurality of vehicles based on whether a message including the diagnostic result has been received.

### BRIEF DESCRIPTION OF DRAWINGS

The above and other aspects, features, and advantages of the present disclosure should be more clearly understood from the following detailed description, taken in conjunction with the accompanying drawings, in which:

FIG. 1 is a diagram illustrating a specific embodiment of a method and an apparatus for diagnostic communication in a vehicle according to an embodiment of the present disclosure and a vehicle;

FIGS. 2A-2D are block diagrams illustrating a plurality of nodes of a method and an apparatus for diagnostic communication in a vehicle according to an embodiment of the present disclosure;

FIGS. 3A, 3B, and 3C are diagrams illustrating a connection operation, a search operation, and a diagnosis operation, of a method and an apparatus for diagnostic communication in a vehicle according to an embodiment of the present disclosure;

FIG. 4 is a flowchart illustrating a method and an apparatus for diagnostic communication in a vehicle according to an embodiment of the present disclosure;

FIG. 5 is a flowchart illustrating a process in which an edge communication node of a method and an apparatus for diagnostic communication in a vehicle according to an embodiment of the present disclosure identifies a received message;

FIG. 6 is a diagram illustrating a vehicle diagnostic apparatus according to an embodiment of the present invention diagnosing a plurality of vehicles; and

FIG. 7 is a flowchart illustrating an operation of a vehicle diagnostic apparatus according to an embodiment of the present disclosure.

### DETAILED DESCRIPTION

Because the present disclosure may have various changes and may have various embodiments of the present disclosure, specific embodiments may be illustrated in the drawings and described in detail. However, this is not intended to limit the present disclosure to specific embodiments. It should be understood to include all modifications, equivalents, and substitutes included in the spirit and technical scope of the present disclosure.

Terms such as first, second, and the like may be used to describe various elements, but the elements should not be limited by the terms. The above terms may be used only for distinguishing one component from another. For example, without departing from the scope of the present disclosure, a first component may be referred to as a second component, and similarly, a second component may also be referred to as a first component. The term “and/or” may include a combination of a plurality of related listed items or any of the plurality of related listed items.

The terms used in the present application may be only used to describe specific embodiments and are not intended to limit the present disclosure. The singular expression may include the plural expression, unless the context clearly dictates otherwise. In the present disclosure, it should be understood that terms such as “include,” “comprise,” or “have” are intended to designate that features, numerals, steps, operations, components, parts, or combination thereof described in the present disclosure exist. However, the terms do not preclude the existence or addition of numbers, steps, operations, components, parts, or combinations thereof.

Unless defined otherwise, all terms used herein, including technical or scientific terms, have the same meaning as commonly understood by one having ordinary skill in the art to which the present disclosure belongs. Terms such as those defined in a commonly used dictionary should be interpreted as having a meaning consistent with the meaning in the context of the related art. The terms should not be interpreted in an ideal or excessively formal manner unless explicitly defined in the present application. When a controller, module, component, device, element, part, unit, or the like of the present disclosure is described as having a purpose or performing an operation, function, or the like, the controller, module, component, device, element, part, unit, or the like should be considered herein as being “configured to” meet that purpose or to perform that operation or function. Each controller, module, component, device, element, part, unit, and the like may separately embody or be included with a processor and a memory, such as a non-transitory computer readable media, as part of the apparatus.

In the present disclosure, a vehicle (including an electric vehicle) refers to a variety of vehicles for moving an object to be transported, such as people, animals, or goods, from a starting point to a destination. These vehicles are not limited to vehicles that run on roads or tracks.

Hereinafter, embodiments of the present disclosure are described in more detail with reference to the accompanying drawings.

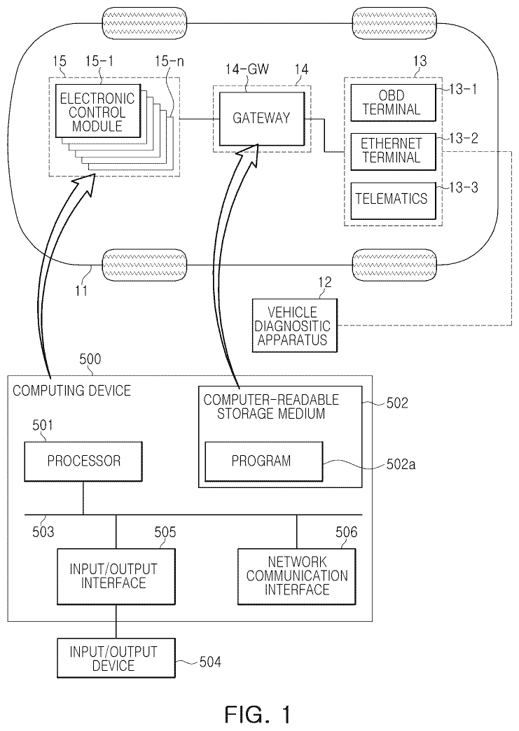

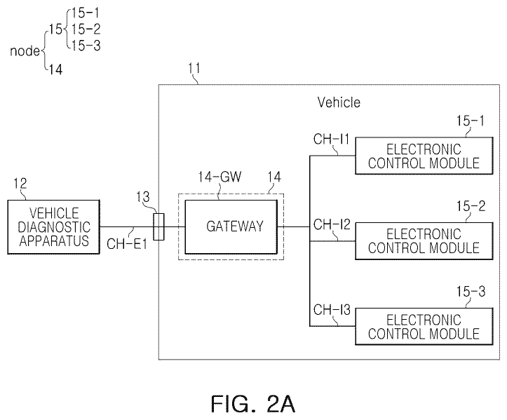

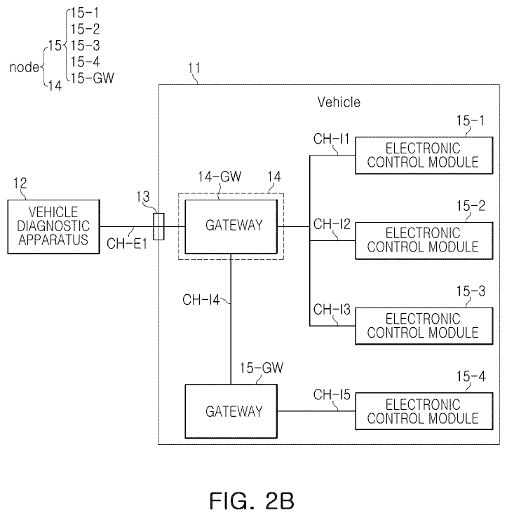

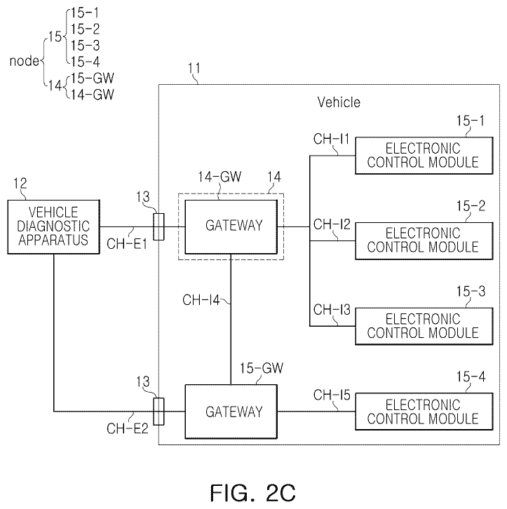

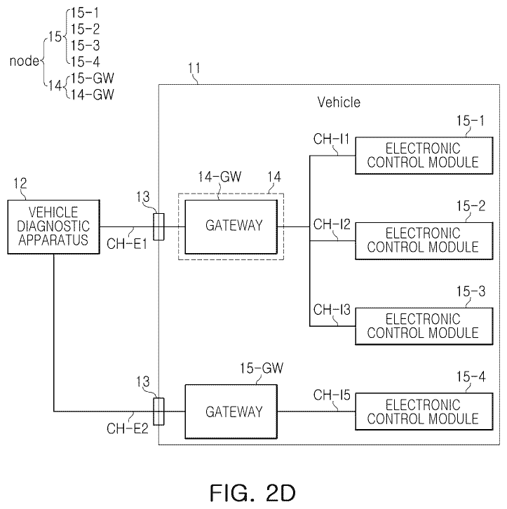

FIG. 1 is a diagram illustrating a specific embodiment of a method and an apparatus for diagnostic communication in a vehicle according to an embodiment of the present disclosure. Referring to FIGS. 1, 2A, and 2B, a vehicle 11 may include a plurality of electronic control modules 15-1 to 15-n for collecting, providing, and transmitting information required for driving, information required for driving, or information for enhancing driving safety to a user, driver, or passenger.

The plurality of electronic control modules 15-1 to 15-n may be connected to each other through a vehicle network and exchange data. The plurality of electronic control modules 15-1 to 15-n may include information collection devices such as sensors and cameras, as well as information processing devices that can perform calculations based on collected information according to preset programs and functions to create and process new information.

For example, each of the plurality of electronic control modules 15-1 to 15-n may be implemented as an electronic control unit (ECU) controlling various devices included in the vehicle. The ECU may be implemented as an ECU that controls an infotainment device (e.g., a display device, a navigation device, an around view monitoring device), or the like. The ECU may also be implemented as an engine control unit, a transmission control unit, an engine management system electronic control unit (EMS ECU), a transmission management system electronic control unit (TMS ECU), an airbag control module (ACU), an anti-locking brake system electronic control unit (ABS ECU), a measuring instrumentation and driver information module.

The plurality of electronic control modules 15-1 to 15-n may be interconnected through a hierarchical network structure via an edge gateway 14-GW. The edge gateway 14-GW may include a computer or software, which enables communication between networks using different communication networks and protocols in a vehicle network. The edge gateway 14-GW may be a network point acting an entrance to different networks and may also act as a passage between different types of networks.

The vehicle 11 may include an edge gateway 14-GW, and the number of edge gateways 14-GW included in the vehicle 11 may be determined corresponding to the number and connection type of a plurality of electronic control modules 15-1 to 15-n mounted in the vehicle.

A vehicle diagnostic apparatus 12 for diagnosing the plurality of electronic control modules 15-1 to 15-n mounted in a vehicle 11 may be connected or linked to the vehicle 11. The vehicle diagnostic apparatus 12 may diagnose the plurality of electronic control modules 15-1 to 15-n connected through a vehicle network of a plurality of different communication methods. The vehicle diagnostic apparatus 12 may be in the form of a terminal that is physically separated from the vehicle but can be connected through terminals mounted in the vehicle. In addition, according to an embodiment, the vehicle diagnostic apparatus 12 may be in the form of a network server that can check the plurality of electronic control modules 15-1 to 15-n mounted in the vehicle and collect data through a wired/wireless communication network.

Meanwhile, there may be an input/output means 13 for transmitting data to perform a diagnostic process and collect the results between the vehicle diagnostic apparatus 12 and the edge gateway 14-GW. For example, the input/output means 13 may include an On-Board Diagnostics (OBD) terminal 13-1 disposed in the vehicle. Here, On-Board Diagnostics (OBD) refers to a diagnostic standard for checking and controlling an electrical/electronic operation status of a vehicle 11. Initially, OBD is used to increase the maintenance efficiency of electronic components, such as engines. However, in addition to this purpose, OBD also serves as an interface as a trip computer showing various vehicle information to a driver.

As the number of electronic control modules 15-1 to 15-n mounted in the vehicle 11 increases and an amount of data transmitted and received by the electronic control modules 15-1 to 15-n increases, an Ethernet communication may be applied to a vehicle network. Depending on the design, a Controller Area Network (CAN) communication may be further applied. For example, a maximum transmission bandwidth of CAN communication, which is a measurement control communication network, may be 1 Mbps. When the number of electronic control modules 15-1 to 15-n in the vehicle 11 increases at this speed, and data traffic increases rapidly due to real-time video transmission (e.g., Topview monitoring), there may be limitations in configuring a vehicle network using only a CAN communication. Meanwhile, a data transmission rate of CAN-FD may be up to 2 Mbit/s in a multi-drop network and be up to 5 Mbit/s in a point-to-point communication, and in the case of Ethernet, a speed of 1 Gbps is also proposed. Therefore, in the process of checking and controlling an electrical/electronic operation status of the vehicle 11, a vehicle diagnostic apparatus 12 may be connected through an Ethernet terminal 13-2.

Depending on the design, a protocol of the vehicle network may be based on Ethernet and CAN, as well as CAN with Flexible Data-Rate (CAN-FD), Local Interconnect Network (LIN) communication, Media Oriented Systems Transport (MOST) communication, or the like, or may be replaced by, CAN-FD, LIN communication, MOST communication, or the like, but an embodiment thereof is not limited thereto.

Depending on the design, the input/output means 13 may use a telematics apparatus 13-3 mounted in the vehicle 11. The telematics apparatus 13-3 is an example of an apparatus that can provide a comprehensive multimedia service for a vehicle using location information and a wireless communication network. The telematics apparatus 13-3 may provide safe driving, emergency rescue, traffic guidance services, or the like, to driver, and may provide infotainment services such as Internet, movies, games, and multimedia to passengers. In addition, the telematics device 13-3 may transmit a diagnostic message for checking and a plurality of electronic control modules 15-1 to 15-n and collecting data from the plurality of electronic control modules 15-1 to 15-n by communicating with a network server for diagnosing operations of devices in the vehicle. The telematics device 13-3 may transmit data transmitted from the plurality of electronic control modules 15-1 to 15-n mounted in the vehicle to the network server.

A diagnostic message that can be transmitted through the edge gateway 14-GW may be transmitted through a User Datagram Protocol (UDP) and/or a Transmission Control Protocol (TCP) among Transport Layer Protocols. For example, for vehicle diagnosis (Diagnostic Access), a diagnostic protocol based on IEEE802.3 and IPv4/IPv6 (Diagnostics over IP, DoIP) may be used, and a diagnostic protocol based on CAN (Diagnostics over CAN, DoCAN) may be used.

A system for vehicle diagnosis may include at least one of a message generator for generating a diagnostic message for diagnosing a plurality of electronic control modules 15-1 to 15-n mounted in a vehicle or a message receiver for recognizing the diagnostic message. The message generator and/or the message receiver may be included in each of a plurality of electronic control modules 15-1 to 15-n, a vehicle diagnostic apparatus 12, and an edge gateway 14-GW.

The plurality of electronic control modules 15-1 to 15-n may communicate with devices connected to other vehicle networks through an edge gateway 14-GW, and the edge gateway 14-GW may perform a switching role for the plurality of vehicle networks. The edge gateway 14-GW may be an interface between the plurality of electronic control modules 15-1 to 15-n. For example, the edge gateway 14-GW transmitting messages and signals according to a diagnostic protocol (e.g., DoIP, DoCAN) for networking with the vehicle diagnostic apparatus 12 based on Ethernet/IP may provide scheduling and protocol conversion functions for communicating with the plurality of electronic control modules 15-1 to 15-n.

For example, a plurality of communication nodes forming a vehicle network may be connected in star topology, bus topology, ring topology, tree topology, mesh topology, or the like, but an embodiment thereof is not limited thereto. For example, each of the plurality of communication nodes forming the vehicle network may support a CAN protocol, a FlexRay protocol, a MOST protocol, a LIN protocol, an Ethernet protocol, or the like, but an embodiment thereof is not limited thereto.

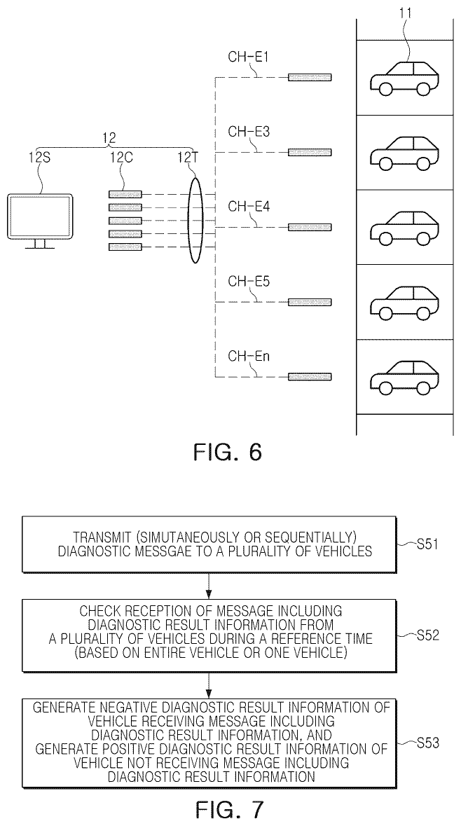

FIGS. 2A-2D are block diagrams illustrating a plurality of nodes of a method and an apparatus for diagnostic communication in a vehicle according to an embodiment of the present disclosure. FIG. 6 is a drawing illustrating a vehicle diagnostic apparatus according to an embodiment of the present disclosure diagnosing a plurality of vehicles.

Referring to FIG. 2A, a plurality of communication nodes may include an edge communication node 14 and a control communication node 15, the edge communication node 14 may include an edge gateway 14-GW, and the control communication node 15 may include a plurality of electronic control modules 15-1, 15-2, and 15-3. Referring to FIG. 2B, the control communication node 15 may further include a control gateway 15-GW and an electronic control module 15-4.

The method and the apparatus for diagnostic communication in a vehicle according to an embodiment of the present disclosure may include an edge communication node 14 receiving a message from outside of a vehicle (e.g., a vehicle diagnostic apparatus 12) and protocol converting or routing the message. The method and the apparatus for diagnostic communication in the vehicle may also include a control communication node 15 receiving the message protocol converted or routed by the edge communication node 14. For example, the edge gateway 14-GW of the edge communication node 14 may perform protocol conversion between a first protocol (e.g., Ethernet, DoIP) and a second protocol (e.g., CAN, DoCAN) for a message transmitted and received between the vehicle diagnostic apparatus 12 and the control communication node 15 or may perform simple routing without protocol conversion.

The edge communication node 14 may be connected to the outside of the vehicle (e.g., a vehicle diagnostic apparatus 12) for communication therewith, via an external channel CH-E1. A plurality of communication nodes may communicate with each other via a plurality of internal channels CH-I1, CH-I2, CH-I3, CH-I4, and CH-I5. For example, each of the external channel CH-E1 and the plurality of internal channels CH-I1, CH-I2, CH-I3, CH-I4, and CH-I5 may have a communication connection status in each of a plurality of layers of a communication model (e.g., OSI standard model, TCP (transfer control protocol)/IP (Internet protocol) model).

For example, according to an Open Systems Interconnection (OSI) standard model, the plurality of layers may be comprised of layers 1 to 7. Layer 1 of a communication node may support PHY functions and may support a transmission rate of 100 megabits per second (Mbps). Layer 2 of a communication node may support IEEE 802.1Q protocol, IEEE 802.1p protocol, IEEE 802.3 protocol, audio video bridging (AVB) protocol (e.g., IEEE 802.1Qav protocol, IEEE 802.1Qat protocol), or the like. Layer 3 of a communication node may support internet protocol version 4 (IPv4), address resolution protocol (ARP), internet control message protocol version 4 (ICMPv4), IEEE 802.1AS, IEEE 1722, or the like. Layer 4 of a communication node may support transfer control protocol (TCP), user datagram protocol (UDP), IEEE 802.1AS, IEEE 1722, or the like. Layers 5 to 7 of a communication node may support diagnostics over internet protocol (DoIP), diagnostics over CAN (DoCAN), EthCC protocol, dynamic host configuration protocol (DHCP), SD protocol, network management (NM) protocol, IEEE 802.1AS, IEEE 1722, or the like.

Referring to FIG. 6, one vehicle diagnostic apparatus 12 may diagnose a plurality of vehicles 11, and a plurality of external channels CH-E1, CH-E3, CH-E4, CH-E5, and CH-En communicate with between a plurality of vehicles 11 and one vehicle diagnostic apparatus 12. Each of the plurality of external channels CH-E1, CH-E3, CH-E4, CH-E5, and CH-En may continuously use vehicle network resources (including Transport Control Protocol (TCP) connection resources) during a channel maintenance period, and the possibility of communication failure/delay in a vehicle network may increase as the number of resources in the vehicle network increases.

Referring to FIGS. 2A and 2B, because one edge communication node 14 may be configured in a vehicle 11, one external channel CH-E1 per a vehicle 11 may be connected to the vehicle diagnostic apparatus 12 for communication therewith. Accordingly, the number of external channels CH-E1 connected to the vehicle diagnostic apparatus 12 for communication therewith may be efficiently reduced, so that vehicle network resources may be efficiently used and the possibility of communication failure/delay in the vehicle network may be reduced.

However, in the present disclosure, the number of external channel communication connections of an edge communication node 14 per a vehicle 11 is not limited to 1. Referring to FIGS. 2C and 2D, the edge communication node 14 may include an edge gateway 14-GW and a control gateway 15-GW, and the edge gateway 14-GW and the control gateway 15-GW may be connected to a plurality of external channels CH-E1 and CH-E2, respectively, for communication therewith. When the plurality of external channels CH-E1 and CH-E2 are connected to an edge communication node 14 for communication therewith, the number of edge communication nodes 14 may be defined as a plurality of edge communication nodes 14.

Referring to FIG. 2C, a control gateway 15-W may communicate with between an edge communication node 14 and an electronic control module 15-4 and may perform protocol conversion or routing for messages transmitted and received between the edge communication node 14 and the electronic control module 15-4. Referring to FIG. 2D, the control gateway 15-GW may not directly be connected to the edge communication node 14 for communication therewith, and the control gateway 15-GW and the edge gateway 14-GW may be independent of each other.

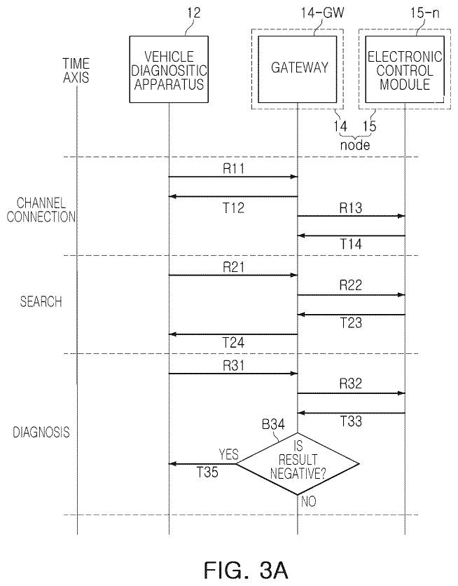

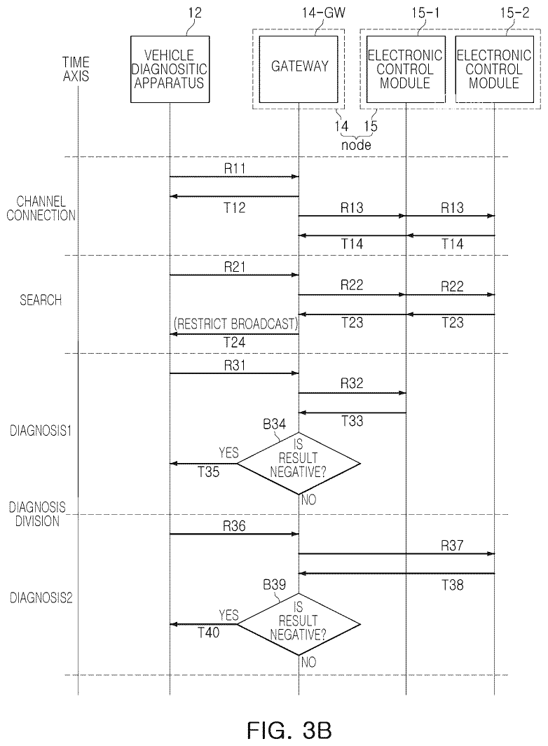

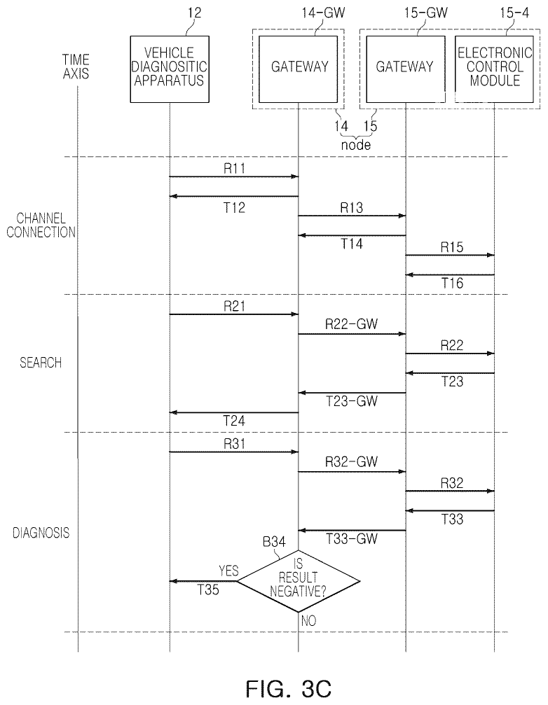

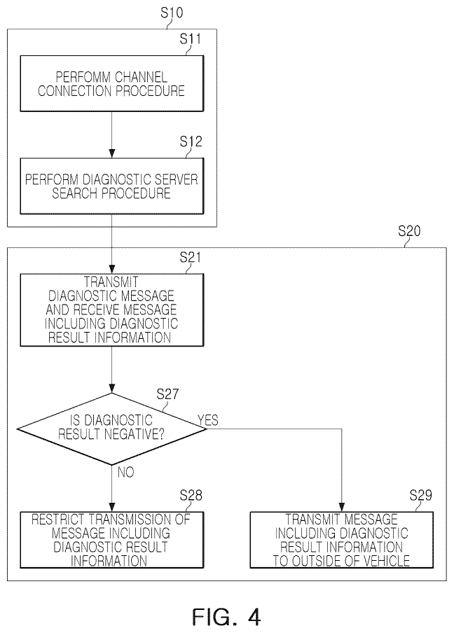

FIGS. 3A, 3B, and 3C are diagrams illustrating a connection operation, a search operation, and a diagnosis operation, of a method and an apparatus for diagnostic communication in a vehicle according to an embodiment of the present disclosure, and FIG. 4 is a flowchart illustrating a method for diagnostic communication in a vehicle according to an embodiment of the present disclosure.

Referring to FIG. 4, the diagnosis operation (S20) may include a receiving operation (S21) and transmitting operations (S27, S28, and S29). Referring to FIGS. 3A and 4, in the diagnosis operation (S20), the outside of the vehicle (e.g., a vehicle diagnostic apparatus 12) of the vehicle 11 may transmit a diagnostic message R31 to an edge communication node 14, and then the edge communication node 14 may sequentially perform the receiving operation (S21) and the transmitting operations (S27, S28, and S29).

Referring to FIGS. 3A and 4, the method and the apparatus for diagnostic communication in a vehicle according to an embodiment of the present disclosure may include an operation in which an edge communication node 14 transmits a diagnostic message R32 to a control communication node 15 and receives a message T33 including a diagnostic result according to the diagnostic message R32. The method and the apparatus for diagnostic communication in a vehicle according to an embodiment of the present disclosure may include operations (S27, S28, and S29) of optionally (B34) transmitting a message T35 including the diagnostic result to the outside (e.g., a vehicle diagnostic apparatus 12) of the vehicle 11 depending on the diagnostic result.

Even if the edge communication node 14 does not transmit a message T35 including one of a positive diagnostic result and a negative diagnostic result to the outside of the vehicle 11 (e.g., a vehicle diagnostic apparatus 12), the outside of the vehicle 11 (e.g., a vehicle diagnostic apparatus 12) may determine whether the diagnostic result of the control communication node 15 in the vehicle 11 is positive or negative based on whether it receives a message T35 including the diagnostic result.

Therefore, a frequency at which the message T35 transmits may be lowered when the edge communication node 14 optionally (B34) transmits the message (T35) based on the diagnostic result, compared to when the edge communication node 14 always transmits the message (T35) including the diagnostic result. As the frequency at which the message (T35) transmits is lowered, the vehicle network resources outside the vehicle 11 (e.g., vehicle diagnostic apparatus 12) may be used more efficiently, and the possibility of communication failure/delay in the vehicle network can be reduced, and the possibility of communication failure/delay in the vehicle network may be reduced. In addition, as the vehicle network resources outside the vehicle 11 (e.g., the vehicle diagnostic apparatus 12) are used more efficiently, the total number of vehicles that the vehicle diagnostic apparatus 12 can diagnose can increase, and a diagnostic speed of the vehicle diagnostic apparatus 12 for multiple vehicles may be faster.

For example, the receiving operation (S21) may include transmitting a diagnostic message (R32) according to diagnostics over internet protocol (DoIP) and receiving a message (T33) including a diagnostic result according to the diagnostic message (R32). For example, a message (T33) including a positive diagnostic result may be defined as a DoIP diagnostic message positive acknowledgement, and a message (T33) including a negative diagnostic result may be defined as a DoIP diagnostic message negative acknowledgement. For example, the edge communication node 14 may determine whether the diagnostic result included in the message (T33) is positive or negative by comparing the message (T33) with the messages defined according to DoIP.

For example, the transmitting operations (S27, S28, and S29) may include checking a diagnostic result (S27), transmitting a message (T35) including a diagnostic result when the diagnostic result is negative (S29), and restricting the transmission of the message (T35) including a diagnostic result if the diagnostic result is positive (S28). Because a rate of positive diagnostic results may be higher than a rate of negative diagnostic results, transmitting (S29) the message (T35) only when the diagnostic result is negative can significantly reduce the frequency at which the message (T35) transmits and can greatly reduce the possibility of communication failure/delay in the vehicle network.

A method and an apparatus for diagnostic communication in a vehicle according to an embodiment of the present disclosure may further include a search operation (S12) in which an edge communication node 14 transmits an identification message (R22) to a control communication node 15 before transmitting a diagnostic message (R32) and receives a response message (T23) to the identification message (R22) from the control communication node 15, and a connection operation (S11) in which the edge communication node 14 is connected to the control communication node 15 for communication therewith, prior to the search operation (S12). The operation prior to diagnosis (S10) may include a connection operation (S11) and/or a search operation (S12). For example, the communication connection may include an Ethernet connection and a Transmission Control Protocol (TCP) connection.

The edge communication node 14, in the connection operation (S11), may transmit and receive messages (R11 and T12) for forming a communication connection (channel formation) to the outside of the vehicle 12 (e.g., a vehicle diagnostic apparatus 12) and then may transmit and receive messages (R11 and T12) for forming a communication connection (channel formation) to the control communication node 15. In other words, an internal channel between the edge communication node 14 and the control communication node 15 may be formed after the formation of an external channel between the edge communication node 14 and the outside of the vehicle 11 (e.g., a vehicle diagnostic apparatus 12), based on a channel propagation method.

For example, the messages (R11, T12, R13, and T14) may follow at least one of an Ethernet connection (Eth connection & Link up) corresponding to a physical layer or a network access layer of a communication model (e.g., OSI standard model, TCP/IP model), a Transmission Control Protocol (TCP) connection corresponding to a transmission layer of the communication model (e.g., OSI standard model, TCP/IP model), and a Diagnostic over Internet Protocol (DoIP) connection corresponding to an application layer of the communication model (e.g., OSI standard model, TCP/IP model). For example, the Ethernet connection (Eth connection & Link up) may include an Ethernet cable being connected between a plurality of communication nodes, the TCP connection may include a TCP handshake procedure being performed, and the DoIP connection may include a DoIP routing activation message being transmitted between a plurality of communication nodes.

The edge communication node 14, in the search operation (S12), may receive an identification message (R21) from outside of the vehicle 11 (e.g., a vehicle diagnostic apparatus 12), and then may transmit an identification message (R22) to a control communication node 15, and then may receive a response message (T23) from the control communication node 15, and then may transmit a response message (T24) to the outside of the vehicle 11 (e.g., a vehicle diagnostic apparatus 12). The outside of the vehicle 11 (e.g., a vehicle diagnostic apparatus 12) may identify the control communication node 15 by transmitting an identification message (R21) to identify the control communication node 15 and by receiving a response message (T24).

For example, the identification messages (R21 and R22) and the response messages (T23 and T24) may be messages according to a diagnostic server search procedure of DoIP, and the identification messages (R21 and R22) may be defined as vehicle identification request messages of DoIP, and the response messages (T23 and T24) may be defined as vehicle identification response messages of DoIP.

Referring to FIGS. 3B and 4, the control communication node 15 may include a plurality of electronic control modules (15-1 and 15-2), and the transmitting operations (S27, S28, and S29) may include optionally (B34, B39) transmitting at least one message (T35, T40) including a negative diagnostic result among a plurality of diagnostic results for a plurality of electronic control modules (15-1 and 15-2) to the outside of the vehicle 11 (e.g., a vehicle diagnostic apparatus 12).

For example, the receiving operation (S21) may include sequentially transmitting a plurality of diagnostic messages (R32 and R37) to a plurality of electronic control modules (15-1 and 15-2), respectively and receiving a plurality of messages (T33 and T38) including a plurality of diagnostic results according to the plurality of diagnostic messages (R32 and R37). The transmitting operations (S27, S28, and S29) may include sequentially transmitting a plurality of messages (T35 and T40) including a plurality of negative diagnostic results to an outside of the vehicle 11 (e.g., a vehicle diagnostic apparatus 12). For example, the receiving operation (S21) may include sequentially transmitting a plurality of diagnostic messages (R32 and R37) to a plurality of electronic control modules (15-1 and 15-2), respectively and receiving a plurality of messages (T33 and T38) including a plurality of diagnostic results according to the plurality of diagnostic messages (R32 and R37). The transmitting operations (S27, S28, and S29) may include sequentially transmitting a plurality of messages (T35 and T40) including a plurality of negative diagnostic results to the outside of the vehicle 11 (e.g., a vehicle diagnostic apparatus 12).

By sequentially transmitting the plurality of diagnostic messages (R32 and R37) and/or sequentially transmitting the plurality of messages (T35 and T40), the outside of the vehicle 11 (e.g., the vehicle diagnostic apparatus 12) may reliably determine which of the plurality of electronic control modules 15-1 and 15-2 has a negative diagnostic result based on a time of reception of the plurality of messages (T35 and T40) and may also prevent communication collisions between the plurality of messages (T35 and T40).

Referring to FIGS. 3B and 4, the control communication node 15 may simultaneously transmit an identification message R22 to the plurality of electronic control modules (15-1 and 15-2). For example, the control communication node 15 may simultaneously transmit the identification message R22 in a broadcasting method of User Datagram Protocol (UDP).

Referring to FIGS. 3B and 4, the search operation S12 may include limiting transmission (T24) of a response message T23 to the outside of the vehicle 11 (e.g., a vehicle diagnostic apparatus 12) when the control communication node 15 transmits the response message T23 to the identification message R22 in a broadcasting method of User Datagram Protocol (UDP).

Unlike TCP messages, the broadcasting method of UDP messages does not require a socket connection procedure (a pre-connection procedure between a plurality of communication nodes). Therefore, depending on the design, messages (R13 and T14) for forming a communication connection (channel formation) between the plurality of communication nodes may be omitted or transmitted and received after receiving a response message T23. However, when a message according to the broadcasting method of UDP is transmitted to the outside of the vehicle 11 (e.g., the vehicle diagnostic apparatus 12), the message may be a factor in an inefficient use of a vehicle network resources. By restricting the transmission T24 of the response message T23 according to the broadcasting method of UDP to the outside of 11 (e.g., the vehicle diagnostic apparatus 12), the inefficient use of the vehicle network resources may be reduced.

Referring to FIG. 2B and FIG. 3C, the edge communication node 14 may transmit and receive messages (R13 and T14) for forming a communication connection with a control gateway 15-GW of the control communication node 15. Thereafter, the control gateway 15-GW may transmit and receive messages (R15 and T16) for forming a communication connection with the electronic control module 15-4. In other words, an internal channel between the control gateway 15-GW and the electronic control module 15-4 may be formed after the formation of the internal channel between the edge communication node 14 and the control gateway 15-GW based on a channel propagation method.

Thereafter, the edge communication node 14 may transmit an identification message R22-GW to a control gateway 15-GW, the control gateway 15-GW may transmit the identification message R22 to an electronic control module 15-4, the electronic control module 15-4 may transmit a response message T23 to a control gateway 15-GW, and the control gateway 15-GW may transmit a response message T23-GW to the edge communication node 14. Accordingly, the outside of the vehicle 11 (e.g., the vehicle diagnostic apparatus 12) may identify the electronic control module 15-4 and/or the control gateway 15-GW.

Thereafter, the edge communication node 14 may transmit a diagnostic message R32-GW to a control gateway 15-GW, the control gateway 15-GW may transmit the diagnostic message R32 to an electronic control module 15-4, the electronic control module 15-4 may transmit a message T33 to a control gateway 15-GW, and the control gateway 15-GW may transmit a message T33-GW to the edge communication node 14. Thereafter, the edge communication node 14 may optionally (B34) transmit a message (T35) to the outside of the vehicle 11 (e.g., a vehicle diagnostic apparatus 12) based on the diagnostic result included in the message T33-GW. The outside of the vehicle 11 (e.g., the vehicle diagnostic device 12) may be informed of the diagnostic results of the electronic control module 15-4 and/or the control gateway 15-GW depending on whether or not the message T35 is received.

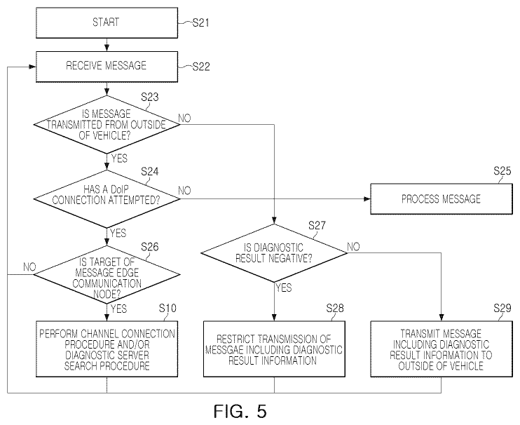

FIG. 5 is a flowchart illustrating a process in which an edge communication node of a method and an apparatus for diagnostic communication in a vehicle according to an embodiment of the present disclosure identifies a received message. Referring to FIG. 2A, FIG. 4, and FIG. 5, an edge communication node 14 may receive (S22) a message after starting an operation (corresponding to the receiving operation (21) of FIG. 4) and may check (S23) whether the received message was transmitted from outside of the vehicle (e.g., the vehicle diagnostic apparatus 12).

Thereafter, the edge communication node 14 may proceed with the transmitting operations (S27, S28, and S29) of FIG. 4 when the received message is transmitted from the control communication node 15 (NO in S23). The edge communication node 14 may check (S24) whether the received message is a DoIP connection attempt when the received message is transmitted from the outside of the vehicle (e.g., the vehicle diagnostic apparatus 12) (YES in S23).

Thereafter, the edge communication node 14 may process (S25) the received message when the received message is not a DoIP connection attempt (NO in S24). For example, message processing (S25) may be implemented as at least one of a vehicle identification request, a vehicle identification response, an announcement message, a routing activation, an alive Check, a DoIP entity status processing, a diagnostic power mode information processing, or a diagnostic message processing, but an embodiment thereof is not limited thereto.

Thereafter, the edge communication node 14 may check (S26) whether a target of the received message is the edge communication node 14 when the received message is a DoIP connection attempt (YES in S24). The edge communication node 14 may perform a channel connection procedure (corresponding to the connection operation S11 of FIG. 4) and/or a diagnostic server search procedure (corresponding to the search operation S12 of FIG. 4) (S10) when the target of the received message is the edge communication node 14 (YES in S26).

FIG. 6 is a drawing illustrating a vehicle diagnostic apparatus according to an embodiment of the present disclosure diagnosing a plurality of vehicles, and FIG. 7 is a flowchart illustrating the operation of a vehicle diagnostic apparatus according to an embodiment of the present disclosure.

Referring to FIGS. 6 and 7, a vehicle diagnostic apparatus 12 according to an embodiment of the present disclosure may be configured to transmit a diagnostic message according to diagnostics over internet protocol (DoIP) to an edge communication node included in each of a plurality of vehicles 11 (S51). The vehicle diagnostic apparatus 12 may be configured to receive a message including a diagnostic result from at least a portion of edge communication nodes among the plurality of vehicles 11 (S52). The vehicle diagnostic apparatus 12 may be configured to determine diagnostic result information for the plurality of vehicles 11 based on whether a message including a diagnostic result is received (S53).

Accordingly, a frequency at which an edge communication node of each of the plurality of vehicles 11 transmits a message including a diagnostic result to a vehicle diagnostic apparatus 12 may be reduced, so that the overall network resources of the vehicle diagnostic apparatus 12 for the plurality of vehicles 11 may be used efficiently, and the possibility of occurrence of communication failure/delay in the vehicle network may be reduced. Accordingly, the total number of vehicles 11 that may be diagnosed by the vehicle diagnostic apparatus 12 may increase, and a diagnostic speed of the vehicle diagnostic apparatus 12 for a plurality of vehicles may be faster.

The vehicle diagnostic apparatus 12 may be connected to each of a plurality of vehicles 11 for communication therewith via a single external channel (CH-E1, CH-E3, CH-E4, CH-E5, CH-En). In other words, the plurality of vehicles 11 and external channels (CH-E1, CH-E3, CH-E4, CH-E5, and CH-En) may correspond one-to-one with each other. Accordingly, the vehicle network resources may be used efficiently, and the possibility of communication failure/delay in the vehicle network may be reduced.

For example, the vehicle diagnostic apparatus 12 may include a computing device 12S, an interface processing unit 12C, and a terminal unit 12T. The interface processing unit 12C may convert a transmission/reception message of the computing device 12S into a communication signal. The terminal unit 12T may support transmission/reception of communication signals between a plurality of vehicles 11 and the vehicle diagnostic apparatus 12.

Meanwhile, referring to FIG. 1, a vehicle 11 according to an embodiment of the present disclosure may include a computing device 500 having a processor 501 and a storage medium 502 recording one or more programs 502a configured to be executable by the processor 501. The one or more programs 502a may include commands for executing the method for diagnostic communication in a vehicle according to an embodiment of the present disclosure.

The computing device 500 may include at least one processor 501, a computer-readable storage medium 502, and a communication bus 503. The computing device 500 may interconnect various other components of the computing device 500, including the processor 501 and the computer-readable storage medium 502. For example, the computing device 500 may be implemented as a microcontroller.

The processor 501 may cause the computing device 500 to operate according to the above-described embodiments. For example, the processor 501 may execute one or more programs stored in the computer-readable storage medium 502. The one or more programs may include one or more computer executable instructions, wherein, when executed by the processor 501, the computer-readable executable instructions may be configured to cause the computing device 500 to perform operations according to an embodiment.

The computer-readable storage medium 502 may be configured to store computer-executable instructions or program code, program data, and/or other suitable forms of information. A program 502a stored on the computer-readable storage medium 502 includes a set of instructions executable by the processor 501. In an embodiment, the computer-readable storage medium 502 may include a memory (a volatile memory such as a random access memory, a non-volatile memory, or a suitable combination thereof), one or more magnetic disk storage devices, optical disk storage devices, flash memory devices, other forms of storage media that can be accessed by the computing device 500 and store desired information, or suitable combinations thereof.

The computing device 500 may also include one or more input/output interfaces 505 and one or more network communication interfaces 506 providing an interface for one or more input/output devices 504. The input/output interface 505 and the network communication interface 506 are connected to the communication bus 503. The network may be one of a cellular network, such as a global system for mobile communications (GSM), enhanced data rates for GSM evolution (EDGE), a general packet radio service (GPRS), a code division multiple access (CDMA), a time division CDMA (TD-CDMA), a universal mobile telecommunications system (UMTS), a long term evolution (LTE), or another cellular network.

The input/output device 504 may be connected to other components of the computing device 500 through the input/output interface 505. The input/output device 504 may include an input device such as a pointing device (a mouse, a trackpad, or the like), a keyboard, a touch input device (a touchpad, a touchscreen, or the like), a voice or sound input device, various types of sensor devices, and/or an imaging device, and an output device such as a display device, a printer, a speaker, and/or a network card. The input/output device 504 may be included inside the computing device 500 as a component constituting the computing device 500 or may be connected to the computing device 500 as a separate device, distinct from the computing device 500.

Meanwhile, embodiments of the present disclosure may include a program for performing the methods described in the present disclosure on a computer and may include a computer readable recording medium including the program. The computer-readable recording medium may include program instructions, local data files, local data structures, or the like, alone or in a combination thereof. The medium may be specially designed and configured for the present disclosure or may be commonly available in the field of computer software. Examples of the computer-readable medium may include a hardware device specially configured to store a magnetic medium such as hard disks, floppy disks and magnetic tapes, an optical recording medium such as CD-ROMs and DVDs, and program instructions such as ROM, RAM, and a flash memory and perform the same. Examples of the program may include not only machine language codes generated by a compiler, but also high-level language codes that may be executed by a computer using an interpreter.

As set forth above, according to an embodiment of the present disclosure, in a method and an apparatus for diagnostic communication in a vehicle, a vehicle including the same, and a vehicle diagnostic apparatus, vehicle network resources may be efficiently reduced, and the possibility of communication failure/delay in a vehicle network may be reduced.

In addition, the total number of vehicles that the vehicle diagnostic apparatus can diagnose may be increased, and a diagnostic speed of the vehicle diagnostic apparatus for a plurality of vehicles may be increased.

The present disclosure is not limited to the above-described embodiments and the accompanying drawings but is defined by the appended claims. Therefore, those having ordinary skill in the art may make various replacements, modifications, or changes without departing from the scope of the present disclosure defined by the appended claims, and these replacements, modifications, or changes should be apparent to those having ordinary skill in the art.

What is claimed is:

1. A method for diagnostic communication in a vehicle, the method comprising:
receiving, by an edge communication node, a message from outside of a vehicle;
protocol converting or routing, by the edge communication node, the message;
transmitting, by the edge communication node, a diagnostic message to a control communication node in the vehicle;
receiving, by the edge communication node, a message including a diagnostic result according to the diagnostic message; and
in a transmitting operation, optionally transmitting, by the edge communication node, a message including the diagnostic result to the outside of the vehicle based on the diagnostic result.

2. The method for diagnostic communication in a vehicle according to claim 1,
wherein the transmitting operation includes:
transmitting the message including the diagnostic result when the diagnostic result is negative; and
restricting transmission of the message including the diagnostic result when the diagnostic result is positive.

3. The method for diagnostic communication in a vehicle according to claim 1, further comprising:
in a search operation:
transmitting, by the edge communication node, an identification message to the control communication node before transmitting the diagnostic message; and
receiving, by the edge communication node, a response message to the identification message from the control communication node.

4. The method for diagnostic communication in a vehicle according to claim 3, further comprising:
in a connection operation, connecting the edge communication node to the control communication node for communication before the search operation,
wherein the communication connection includes an Ethernet connection and a Transmission Control Protocol (TCP) connection.

5. The method for diagnostic communication in a vehicle according to claim 4,
wherein the search operation includes:
restricting transmission of the response message to the outside of the vehicle when the control communication node transmits a response message to the identification message in a broadcasting method of User Datagram Protocol (UDP).

6. The method for diagnostic communication in a vehicle according to claim 1,
wherein the control communication node includes a plurality of electronic control modules, and
wherein the transmitting operation includes transmitting at least one message including a negative diagnostic result among a plurality of diagnostic results for the plurality of electronic control modules to the outside of the vehicle.

7. The method for diagnostic communication in a vehicle according to claim 6,
wherein the receiving operation includes:
sequentially transmitting a plurality of diagnostic messages to the plurality of electronic control modules, respectively; and
receiving a plurality of messages including a plurality of diagnostic results according to the plurality of diagnostic messages, and
wherein the transmitting operation includes sequentially transmitting a plurality of messages including a plurality of negative diagnostic results to the outside of the vehicle.

8. The method for diagnostic communication in a vehicle according to claim 6, further comprising:
in a search operation:
transmitting, by the edge communication node, an identification message to the control communication node before transmitting the diagnostic message; and
receiving, by the edge communication node, a response message to the identification message from the control communication node; and
in a connection operation, connecting the edge communication node, the control communication node for communication before the search operation.

9. The method for diagnostic communication in a vehicle according to claim 1,
wherein the receiving operation includes:
transmitting the diagnostic message according to diagnostics over internet protocol (DoIP); and
receiving a message including a diagnostic result according to the diagnostic message.

10. An apparatus for diagnostic communication in a vehicle, the apparatus comprising:
an edge communication node configured to receive a message from outside of a vehicle and protocol convert or route the message; and
a control communication node configured to receive the message protocol converted or routed by the edge communication node,
wherein the edge communication node is further configured to transmit a diagnostic message to the control communication node,
wherein the control communication node is further configured to transmit a message including a diagnostic result according to the diagnostic message to the edge communication node, and
wherein the edge communication node is further configured to optionally transmit a message including the diagnostic result to the outside of the vehicle based on the diagnostic result.

11. The apparatus for diagnostic communication in a vehicle according to claim 10,
wherein the edge communication node is further configured to:
transmit a message including the diagnostic result when the diagnostic result is negative; and
restrict the transmission of the message including the diagnostic result when the diagnostic result is positive.

12. The apparatus for diagnostic communication in a vehicle according to claim 10,
wherein the edge communication node is connected to the control communication node for communication and is further configured to transmit an identification message to the control communication node, and
wherein the control communication node is further configured to transmit a response message to the identification message to the edge communication node.

13. The apparatus for diagnostic communication in a vehicle according to claim 12,
wherein the communication connection includes an Ethernet connection and a Transmission Control Protocol (TCP) connection,
wherein the control communication node is further configured to transmit a response message to the identification message in a broadcasting method of User Datagram Protocol (UDP), and
wherein the edge communication node is further configured to restrict the transmission of the response message to the outside of the vehicle.

14. The apparatus for diagnostic communication in a vehicle according to claim 10,
wherein the control communication node includes a plurality of electronic control modules, and
wherein the edge communication node is further configured to transmit at least one message including a negative diagnostic result among a plurality of diagnostic results for the plurality of electronic control modules to the outside of the vehicle.

15. The apparatus for diagnostic communication in a vehicle according to claim 14,
wherein the edge communication node is further configured to sequentially transmit a plurality of diagnostic messages to the plurality of electronic control modules, respectively,
wherein the plurality of electronic control modules is configured to transmit a plurality of messages including a plurality of diagnostic results according to the plurality of diagnostic messages to the edge communication node, and
wherein the edge communication node sequentially is further configured to transmit a plurality of messages including a plurality of negative diagnostic results to the outside of the vehicle.

16. The apparatus for diagnostic communication in a vehicle according to claim 10, wherein the edge communication node is further configured to transmit the diagnostic message according to diagnostics over internet protocol (DoIP) to the control communication node.

17. The apparatus for diagnostic communication in a vehicle according to claim 10,
wherein the control communication node includes a control gateway and a plurality of electronic control modules, and
wherein the control gateway is connected between the edge communication node and at least a portion of the plurality of electronic control modules for communication.

18. A vehicle, comprising:
a computing device having a processor and a storage medium on which one or more programs configured to be executed by the processor is recorded,
wherein the one or more programs include commands for executing the method for diagnostic communication in the vehicle according to claim 1.

19. A vehicle diagnostic apparatus, the vehicle diagnostic apparatus configured to:
transmit a diagnostic message according to diagnostics over internet protocol (DoIP) to an edge communication node included in each of a plurality of vehicles;
receive a message including a diagnostic result from at least a portion of edge communication nodes among the plurality of vehicles; and
determine diagnostic result information for the plurality of vehicles based on whether a message including the diagnostic result has been received.

20. The vehicle diagnostic apparatus of claim 19, wherein the vehicle diagnostic apparatus is connected to each of the plurality of vehicles for communication via a single external channel.
